(19) United States
(12) Patent Application Publication
(10) Pub. No.: US 2014/0118250 A1
(43) Pub. Date: May 1, 2014

(54) POINTING POSITION DETERMINATION

(71) Applicant: UNIVERSITY OF SEOUL INDUSTRY COOPERATION FOUNDATION, (US)

(72) Inventor: Jin Suk KIM, Seoul (KR)

(73) Assignee: UNIVERSITY OF SEOUL INDUSTRY COOPERATION FOUNDATION, Seoul (KR)

(21) Appl. No.: 13/777,252

(22) Filed: Feb. 26, 2013

(30) Foreign Application Priority Data
Oct. 25, 2012 (KR) 10-2012-0119029

(51) Int. Cl. G06F 3/041

(52) U.S. Cl. CPC G06F 3/041
USPC 345/157

(57) ABSTRACT

A glasses may include a glasses frame configured to detect a touch input to the glasses frame, and a processor configured to determine a pointing position within an image displayed by a display based, at least in part, on the touch input.

### CROSS-REFERENCE TO RELATED PATENT APPLICATION

This application claims priority from the Korean Patent Application No. 10-2012-0119029, filed on Oct. 25, 2012 in the Korean Intellectual Property Office, the entire disclosure of which is incorporated herein by reference in its entirety.

### FIELD

Example embodiments broadly relate to glasses and methods for determining a pointing position within an image displayed by a display based on a touch input to a glasses frame.

### BACKGROUND

There are various mechanisms for allowing a user to view a display without having to look down. For example, heads-up displays (HUDs) or head-mounted displays (HMDs) have been developed to allow a wearer to see displays without looking down at a monitor or a screen of a computer. Recently, a glasses type of HUDs/HMDs is becoming more popular. However, with existing technology, a wearer of a HUD/HMD has to use a pointing device such as a mouse to select an object shown on the displays.

### SUMMARY

According to an aspect of example embodiments, there is provided a glasses including a glasses frame configured to detect a touch input to the glasses frame, and a processor configured to determine a pointing position within an image displayed by a display based, at least in part, on the touch input.

The display may be separated from the glasses, and the processor may be further configured to transmit the pointing position to the display, and the pointing position may be shown on the image displayed by the display.

The glasses may further comprise: a non-transparent member coupled with the glasses frame. The display may be formed on the non-transparent member, and the processor may be further configured to transmit the pointing position to the display, and the pointing position may be shown on the image displayed by the display.

The glasses may further comprise: a lens configured to be coupled with the glasses frame. The display may be formed on the lens, and the processor may be further configured to transmit the pointing position to the display, and the pointing position may be shown on the image displayed by the display.

The glasses may further comprise: a camera configured to be coupled with the glasses frame and capture the image around the glasses.

The image may be transmitted from an outside of the glasses to the display via a network.

The glasses may further comprise: a memory configured to store the image. The display may be configured to display the image stored in the memory.

The processor may comprise: a receiving unit configured to receive the detected touch input from the glasses frame, a determination unit configured to determine the pointing position within the image based, at least in part, on the detected touch input, and a transmitting unit configured to transmit the pointing position to the display.

The glasses frame may comprise: a first glasses frame configured to detect a first direction touch input to the first glasses frame, and a second glasses frame configured to detect a second direction touch input to the second glasses frame.

The first direction touch input may be associated with an x-axis direction on the display, and the second direction touch input may be associated with a y-axis direction on the display.

The glasses frame may further comprise: a third glasses frame configured to detect a third direction touch input to the third glasses frame.

The first direction touch input may be associated with an x-axis direction on the display, and the second direction touch input may be associated with a y-axis direction on the display, and the third direction touch input may be associated with a z-axis direction on the display.

The glasses may further comprise: an auxiliary input unit configured to receive an input for moving the pointing position.

The auxiliary input unit may include at least one of a scroll and a ball.

The glasses frame may have thereon an on/off switch configured to stop or start an operation of the processor.

The glasses frame may have thereon a click unit configured to receive an instruction to click an object corresponding to the pointing position within the image.

The image may be zoomed in or zoomed out on the display based, at least in part, on the touch input.

According to another aspect of example embodiments, a pointing device associated with a glasses comprises: a touch sensor configured to detect a touch input to a glasses frame of the glasses, and a processor configured to determine a pointing position within an image displayed by a display based, at least in part, on the touch input.

According to another aspect of example embodiments, a method performed under control of a glasses comprises: detecting a touch input to a glasses frame of the glasses, and determining a pointing position within an image displayed by a display based, at least in part, on the touch input.

According to another aspect of example embodiments, there is provided a non-transitory computer-readable storage medium having stored thereon computer-executable instructions that, in response to execution, cause a glasses to perform a method including detecting a touch input to a glasses frame of the glasses, and determining a pointing position within an image displayed by a display based, at least in part, on the touch input.

### BRIEF DESCRIPTION OF THE DRAWINGS

Non-limiting and non-exhaustive example embodiments will be described in conjunction with the accompanying drawings. Understanding that these drawings depict only example embodiments and are, therefore, not intended to limit its scope, the example embodiments will be described with specificity and detail taken in conjunction with the accompanying drawings, in which:

FIG. 1 schematically shows an illustrative example of glasses in accordance with at least some embodiments described herein;

FIG. 2 schematically shows another illustrative example of glasses in accordance with at least some embodiments described herein;

FIG. 3 schematically shows an illustrative example of an image displaying environment in which glasses and a separate display communicate with each other via a network in accordance with at least some embodiments described herein;

FIG. 4 shows a schematic block diagram illustrating an architecture of glasses in accordance with example embodiments described herein;

FIG. 5 schematically shows another illustrative example of glasses in accordance with at least some embodiments described herein;

FIG. 6 shows a schematic block diagram illustrating an architecture of a pointing device associated with glasses in accordance with example embodiments described herein; and

FIG. 7 shows an example processing flow for determining a pointing position within an image.

### DETAILED DESCRIPTION

Hereinafter, some embodiments will be described in detail. It is to be understood that the following description is given only for the purpose of illustration and is not to be taken in a limiting sense. The scope of the invention is not intended to be limited by the embodiments described hereinafter with reference to the accompanying drawings, but is intended to be limited only by the appended claims and equivalents thereof.

It is also to be understood that in the following description of embodiments any direct connection or coupling between functional blocks, devices, components, circuit elements or other physical or functional units shown in the drawings or described herein could also be implemented by an indirect connection or coupling, i.e. a connection or coupling comprising one or more intervening elements. Furthermore, it should be appreciated that functional blocks or units shown in the drawings may be implemented as separate circuits in some embodiments, but may also be fully or partially implemented in a common circuit in other embodiments. In other words, the provision of functional blocks in the drawings is intended to give a clear understanding of the various functions performed, but is not to be construed as indicating that the corresponding functions are necessarily implemented in physically separate entities.

It is further to be understood that any connection which is described as being wire-based in the following specification may also be implemented as a wireless communication connection unless noted to the contrary.

The features of the various embodiments described herein may be combined with each other unless specifically noted otherwise. On the other hand, describing an embodiment with a plurality of features is not to be construed as indicating that all those features are necessary for practicing the present invention, as other embodiments may comprise less features and/or alternative features.

In some examples, a display may be mounted or formed on a lens of glasses and an image may be displayed by the display. The displayed image may be captured by a camera which is installed on a glasses frame of the glasses, or the image may be transmitted to the glasses via a network from an outside of the glasses. While wearing the glasses and viewing the image, a wearer of the glasses may touch the glasses frame of the glasses and the glasses may detect or sense the touch input from the wearer. The glasses may determine a pointing position based, at least in part, on the detected touch input and the determined pointing position may be shown on the image.

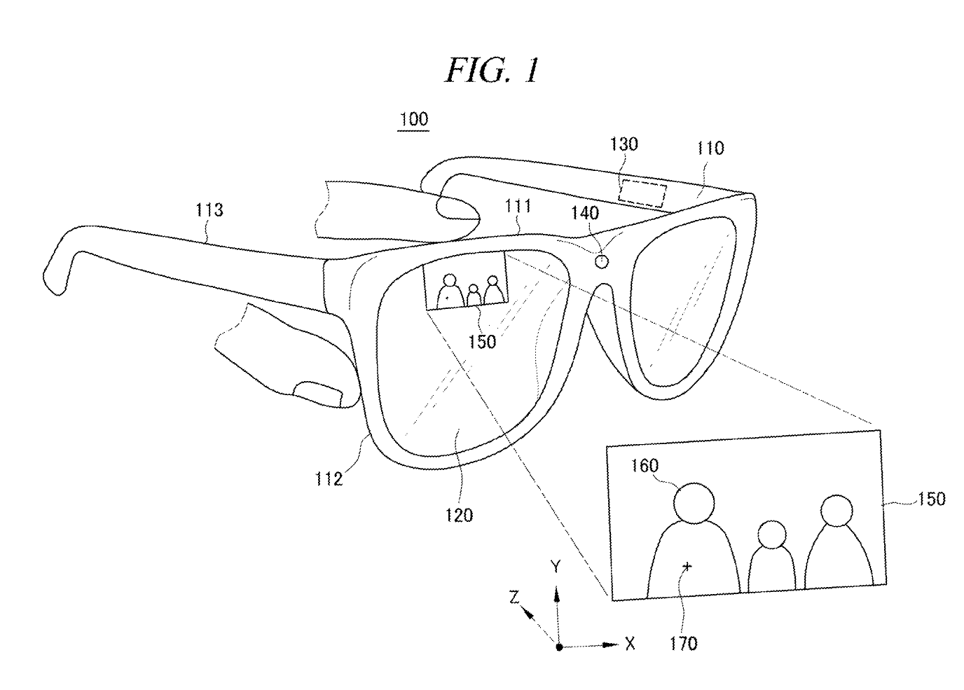

FIG. 1 schematically shows an illustrative example of glasses in accordance with at least some embodiments described herein. As depicted in FIG. 1, glasses 100 may include a glasses frame 110, a lens 120, a processor 130 and a camera 140.

Glasses frame 110 may detect a touch input to glasses frame 110. The touch input to glasses frame 110 may be made by a wearer of glasses 100. By way of examples, the touch input may be detected by using any of well-known touch sensitivity technologies, including but not limited to capacitive, resistive, infrared, and surface acoustic wave technologies, as well as other technologies using proximity sensor arrays or elements for sensing one or more contact points with glasses frame 110.

Further, glasses frame 110 may include a first glasses frame 111, a second glasses frame 112 and a third glasses frame 113. First glasses frame 111 may detect a first direction touch input to first glasses frame 111, and second glasses frame 112 may detect a second direction touch input to second glasses frame 112, and third glasses frame 113 may detect a third direction touch input to third glasses frame 113. In some embodiments, the first direction touch input may be associated with an x-axis direction on a display 150, and the second direction touch input may be associated with a y-axis direction on display 150, and the third direction touch input may be associated with a z-axis direction on display 150.

By way of example, as depicted in FIG. 1, if an image 160 is a two-dimensional image, there is no need for detecting the third direction touch input to third glasses frame 113. Therefore, in such a case, it is sufficient to detect only the first direction touch input to first glasses frame 111, and the second direction touch input to second glasses frame 112.

Lens 120 may be coupled with glasses frame 110, and the wearer of glasses 100 may view something outside of glasses 100 such as a landscape, a monitor or a screen through lens 120. In some embodiments, display 150 may be mounted or formed on lens 120.

Processor 130 may determine a pointing position 170, which will be shown on image 160, based, at least in part, on the touch input that was made to glasses frame 110 by the wearer of glasses 100.

Further, processor 130 may transmit determined pointing position 170 to display 150. Processor 130 may determine an x-coordinate of pointing position 170 which will be displayed within display 150 based on the detected first direction touch input, a y-coordinate of pointing position 170 which will be displayed within display 150 based on the detected second direction touch input, and a z-coordinate of pointing position 170 which will be displayed within display 150 based on the detected third direction touch input.

Camera 140 may be mounted on or coupled with glasses frame 110 of glasses 100. Camera 140 may capture image 160 around glasses 100. In this case, image 160 may be a part of view that the wearer sees through lens 120. By way of examples, camera 140 may include various camera lenses such as a wide-angle lens, a telephoto lens, a zoom lens, a fish-eye lens and a lens for infrared optics. For example, camera 140 may capture a bright image at night by using the lens for infrared optics. Camera 140 may further include a filter installed on the camera lens. Although glasses 100 is illustrated to have a single camera 140 in FIG. 1, the number of cameras coupled with glasses 100 can be increased. By way of example, glasses 100 may have multiple cameras coupled with glasses 100 to capture a wide image, a non-wobbly image or a three-dimensional image outside of glasses 100.

Display 150 may be mounted or formed on lens 120 coupled with glasses frame 110. For example, display 150 may be any kind of heads-up displays (HUDs) or head-mounted displays (HMDs). By way of example, display 150 may be positioned on an upper part of lens 120, but the position of display 150 can be any position on lens 120. Further, the illustrated size or shape of display 150 can also be modified. By way of example, display 150 may include a glass panel, a transparent film, a transparent sheet and so forth.

Image 160 may be displayed by display 150 mounted or formed on lens 120. Image 160 may be one of a two-dimensional image and a three-dimensional image. In some embodiments, glasses 100 may previously store contents such as a movie, a television broadcasting program, a music video and so forth, and then image 160 included in the contents may be displayed by display 150. The wearer may operate glasses 100 to reproduce the stored contents on display 150.

In some embodiments, image 160 may be captured by camera 140 installed on glasses frame 110, and then captured image 160 may be displayed on display 150. Further, glasses 100 may receive additional information on at least one object within captured image 160, and the received additional information may be displayed with captured image 160. For example, while viewing the additional information, the wearer may find a particular spot such as a restaurant where the wearer wants to visit from a crowded street. Further, since display 150 may display captured image 160 which is an outside view around glasses 100, glasses 100 may be useful to the wearer who has poor eye sight.

In some other embodiments, image 160 may be transmitted from outside of glasses 100 to a communication module of glasses 100 via a network, and then transmitted image 160 may be displayed by display 150. By way of example, transmitted image 160 may include a real time broadcasting contents such as an IPTV contents.

A network is an interconnected structure of nodes, such as terminals and servers, and allows sharing of information among the nodes. By way of example, but not limited to, the network may include a wired network such as LAN (Local Area Network), WAN (Wide Area Network), VAN (Value Added Network) or the like, and all kinds of wireless network such as a mobile radio communication network, a satellite network, a Bluetooth, Wibro (Wireless Broadband Internet), Mobile WiMAX, HSDPA (High Speed Downlink Packet Access) or the like.

Pointing position 170 may be transmitted to display 150, and then transmitted pointing position 170 may be shown on image 160 displayed by display 150.

By way of example, if the wearer touches glasses frame 110 with his/her finger and then moves the touch point on glasses frame 110, glasses frame 110 may detect a movement trace of the touch input on glasses frame 110, and then processor 130 may determine a movement trace of pointing position 170 based on the movement trace of the touch input on glasses frame 110. Further, processor 130 may transmit the movement trace of pointing position 170 to display 150, and then pointing position 170 shown on image 160 may be moved continuously in response to the received movement trace.

Further, a projector may be installed on a certain position of glasses 100 to shoot beams to a transparent display area on lens 120 of glasses 100 to display something on the transparent display area.

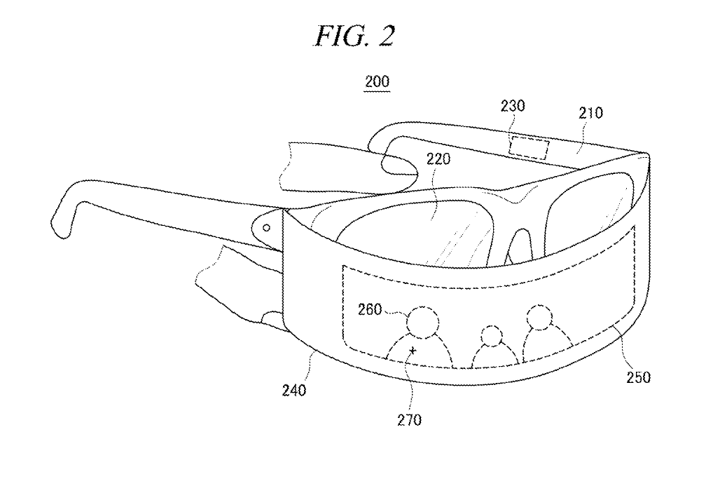

FIG. 2 schematically shows another illustrative example of glasses in accordance with at least some embodiments described herein. As depicted in FIG. 2, glasses 200 may include a glasses frame 210, a lens 220, a processor 230 and a non-transparent member 240. As compared to glasses 100 of FIG. 1, glasses 200 may further include non-transparent member 240, and a display 250 which displays an image 260 is mounted or formed on non-transparent member 240 not on lens 220. In this embodiment, lens 220 is optional and may be omitted from glasses 200.

Since the function and operation of glasses frame 210, lens 220 and processor 230 are similar to those of glasses frame 110, lens 120 and processor 130 discussed above in conjunction with FIG. 1, redundant description thereof will be omitted herein.

Non-transparent member 240 may be coupled with glasses frame 210. By way of example, but not limited to, non-transparent member 240 may be fixed to glasses frame 210, or configured to be moved up and down by a hinge provided to glasses frame 210. Display 250 may be mounted or formed on non-transparent member 240. If a wearer does not want to watch display 250, the wearer can move up non-transparent member 240 or remove non-transparent member 240.

Although, glasses 200 are illustrated to have a single display 250 in FIG. 2, in some embodiments, two displays may be mounted or formed on non-transparent member 240. By way of example, a first display may be mounted or formed on a right portion of non-transparent member 240, and a second display may be mounted or formed on a left portion of non-transparent member 240. By using these two displays, glasses 200 may provide the wearer with a 3-dimensional image.

Because glasses 200 maintain the wearer's peripheral vision free from obstruction, the wearer can view confidential information in a crowded environment without disclosing the displayed information to others. By way of example, in such a case, glasses 200 can allow the user to watch displayed image 260 on a private display 250. In some embodiments, glasses 200 may further include speakers or earphones to allow the wearer to listen sounds or voices.

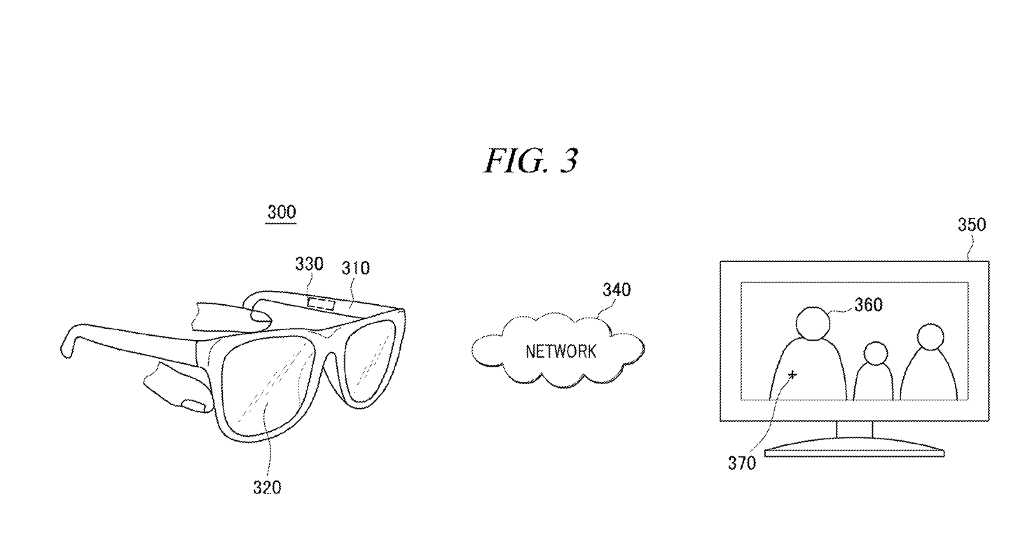

FIG. 3 schematically shows an illustrative example of an image displaying environment in which glasses and a separate display communicate with each other via a network in accordance with at least some embodiments described herein. As depicted in FIG. 3, the image displaying environment may include glasses 300, a network 340 and a separate display 350. Here, glasses 300 may include a glasses frame 310, a lens 320 and a processor 330. As compared to glasses 100 of FIG. 1, separate display 350 of FIG. 3 which displays an image 360 is distanced away from glasses 300. Further, in this embodiment, lens 320 is optional and may be omitted from glasses 300.

Since the function and operation of glasses frame 310 and lens 320 are similar to those of glasses frame 110 and lens 120 discussed above in conjunction with FIG. 1, redundant description thereof will be omitted herein.

Processor 330 may determine a pointing position 370 which will be shown on image 360 based, at least in part, on a touch input made to glasses frame 310 by a wearer of glasses 300. Processor 330 may transmit determined pointing position 370 to separate display 350 via network 340 and then, transmitted pointing position 370 may be shown on image 360 displayed by separate display 350.

Separate display 350 may be connected with glasses 300 via network 340. By way of example, but not limited to, separate display 350 may include a monitor, a television, or a screen which is associated with various electronic devices such as a computer, a mobile device, or a beam projector. While wearing glasses 300, the wearer can adjust pointing position 370 shown on image 360 displayed on separated display 350.

By way of example, the computer may include a notebook provided with a WEB Browser, a desktop, a laptop, and others. The mobile device is, for example, a wireless communication device assuring portability and mobility and may include any types of handheld-based wireless communication devices such as a personal communication system (PCS), global system for mobile communications (GSM), personal digital cellular (PDC), personal handy phone system (PHS), personal digital assistant (PDA), international mobile telecommunication (IMT)-2000, code division multiple access (CDMA)-2000, W-code division multiple access (W-CDMA), a wireless broadband Internet (Wibro) device, and a smart phone.

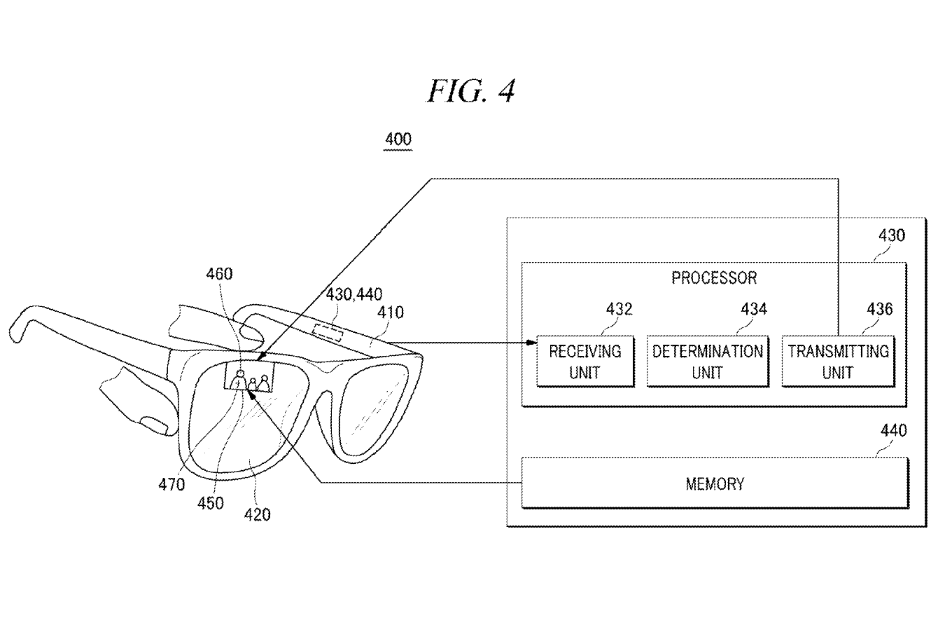

FIG. 4 shows a schematic block diagram illustrating an architecture of glasses in accordance with example embodiments described herein. As depicted in FIG. 4, glasses 400 may include a glasses frame 410, a lens 420, a processor 430 and a memory 440. As compared to glasses 100 of FIG. 1, processor 430 may include a receiving unit 432, a determination unit 434 and a transmitting unit 436, and glasses 400 may further include memory 440. Although illustrated as discrete components, various components may be divided into additional components, combined into fewer components, or eliminated altogether while being contemplated within the scope of the disclosed subject matter.

Since the function and operation of glasses frame 410, lens 420 and processor 430 are similar to those of glasses frame 110, lens 120 and processor 130 discussed above in conjunction with FIG. 1, redundant description thereof will be omitted herein. In some embodiments, processor 430 and memory 440 may be installed inside of glasses frame 410.

Glasses frame 410 may detect at least one touch input to glasses frame 410, and then transmit the at least one detected touch input to receiving unit 432. Receiving unit 432 may receive the detected touch input from glasses frame 410. Determination unit 434 may determine a pointing position 470 which will be shown on an image 460 displayed by a display 450 based, at least in part, on the received touch input. Transmitting unit 436 may transmit determined pointing position 470 to display 450 and then, transmitted pointing position 470 may be shown on image 460 displayed by display 450.

Memory 440 may previously store at least one image including image 460, and the at least one stored image may be displayed by display 450. By way of example, but not limited to, memory 440 may include high speed random access memory, non-volatile memory such as one or more magnetic disk storage devices, flash memory devices, or other non-volatile solid state memory devices, network attached storage accessed via a network, or any suitable combination thereof.

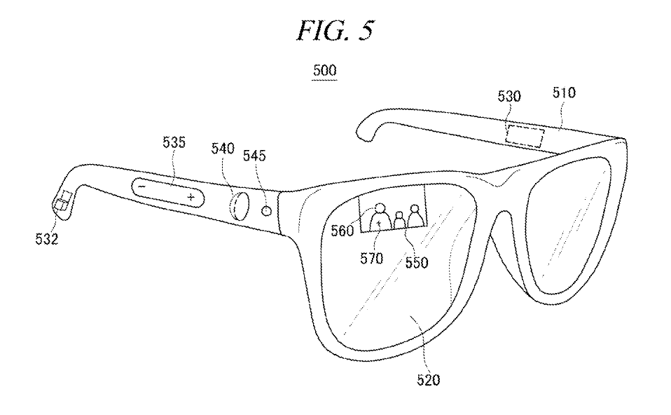

FIG. 5 schematically shows another illustrative example of glasses in accordance with at least some embodiments described herein. As depicted in FIG. 5, glasses 500 may include a glasses frame 510, a lens 520, a processor 530, an on/off switch 532, a zoom in/out button 535, an auxiliary input unit 540 and a click unit 545. In comparison with glasses 100 of FIG. 1, glasses 500 may further include on/off switch 532, zoom in/out button 535, auxiliary input unit 540 and click unit 545. It will be apparent to those skilled in the art that at least one of on/off switch 532, zoom in/out button 535, auxiliary input unit 540 and click unit 545 may be further installed on one of glasses 100 to 300 of FIGS. 1 to 3.

The function and operation of glasses frame 510, lens 520 and processor 530 are similar to those of glasses frame 110, lens 120 and processor 130 discussed above in conjunction with FIG. 1.

On/off switch 532 may stop or start an operation of glasses 500. By way of example, if a wearer of glasses 500 wants to use a function of glasses 500 such as displaying image 560 and/or determining a pointing position 570 on display 550, the wearer may turn on on/off switch 532 and then the operation of glasses 500 may be started. Further, the wearer wants to stop to the operation of glasses 500, the wearer may turn off on/off switch 532 and then the operation of glasses 500 may be stopped. By way of example, but not limited to, on/off switch 532 may be a single button or two buttons including an “on” button and an “off” button. By way of example, if there is no operation of glasses 500 for a predetermined time, glasses 500 may be automatically switched to an “off” mode.

By using zoom in/out button 535, image 560 displayed by display 550 may be zoomed in or zoomed out. When a certain object on image 560 is too small or large, zoom in/out button 535 can be used. By way of example, when the wearer push a “+” button of zoom in/out button 535, image 560 may be zoomed in, and when the wearer push a “−” button of zoom in/out button 535, image 560 may be zoomed out. According to the number of pushing the “+” or “−” button, the degree of zoom in/out with respect to image 560 may be determined. By way of example, when the wearer drags her/his finger from “−” button to “+” button of zoom in/out button 535, image 560 may be zoomed in, and when the wearer drags her/his finger from “+” button to “−” button of zoom in/out button 535, image 560 may be zoomed out.

In some embodiments, zoom in/out button 535 may be omitted from glasses 500. In such a case, image 560 may be zoomed in or out by making a predefined gesture on glasses frame 510. By way of example, image 560 may be zoomed in by increasing a distance between two fingers on glasses frame 510. Similarly, image 560 may be zoomed out by decreasing a distance between two fingers on glasses frame 510.

Auxiliary input unit 540 may receive an auxiliary input for moving pointing position 570 from the wearer. In some embodiments, auxiliary input unit 540 may include at least one of a scroll and a ball. By way of example, if the wearer wants to slightly move pointing position 570, the wearer may use auxiliary input unit 540 for fine adjustment instead of touching glasses frame 510. By manipulating auxiliary input unit 540, the wearer of glasses 500 can adjust pointing position 570 more accurately.

Click unit 545 may receive from the wearer an instruction to select an object corresponding to pointing position 570 within image 560. While pointing position 570 is being shown on image 560, if the wearer pushes click unit 545, the object within image 560 corresponding to pointing position 570 may be selected. In some examples, if the wearer double clicks click unit 545 with respect to the selected object, glasses 500 may receive information associated with the selected object from an external information providing server, and then glasses 500 may display the received information on display 550.

The positions of on/off switch 532, zoom in/out button 535, auxiliary input unit 540 and click unit 545 can be modified in various ways. Further, although glasses 500 in FIG. 5 are illustrated to include all of on/off switch 532, zoom in/out button 535, auxiliary input unit 540 and click unit 545, in some embodiments, at least one of on/off switch 532, zoom in/out button 535, auxiliary input unit 540 and click unit 545 can be omitted from glasses 500.

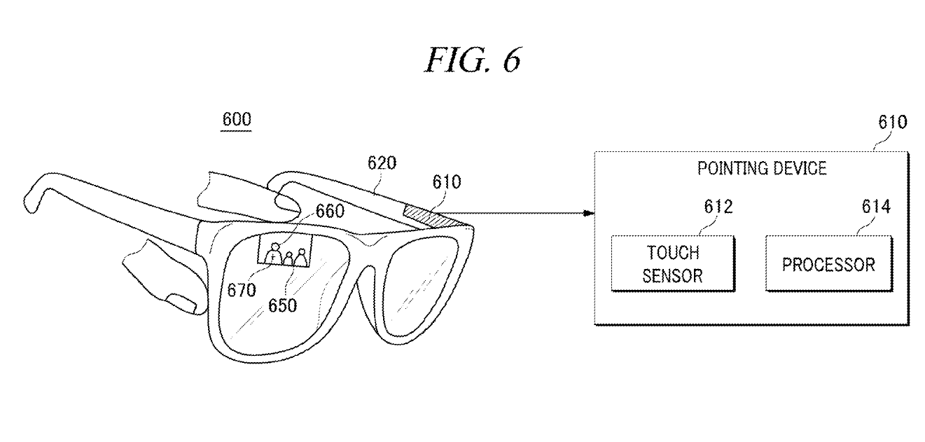

FIG. 6 shows a schematic block diagram illustrating an architecture of a pointing device associated with glasses in accordance with example embodiments described herein. As depicted in FIG. 6, pointing device 610 may be installed on glasses 600 and pointing device 610 may include a touch sensor 612 and a processor 614. Although illustrated as discrete components, various components may be divided into additional components, combined into fewer components, or eliminated altogether while being contemplated within the scope of the disclosed subject matter.

Touch sensor 612 may detect a touch input to a glasses frame 620 of glasses 600 by using any one of well-known touch input detecting schemes. Alternatively, touch sensor 612 may detect the touch input by calculating a contact position on glasses frame 620 with at least one camera included in touch sensor 612.

Processor 614 may determine a pointing position 670 which will be shown on an image 660 displayed by a display 650 based, at least in part, on the detected touch input. Then, processor 614 may transmit determined pointing position 670 to display 650.

By installing pointing device 610 on glasses 600, typical glasses 600 may perform functions including detecting a touch input and determining pointing position 670 as done by glasses 100 of FIG. 1.

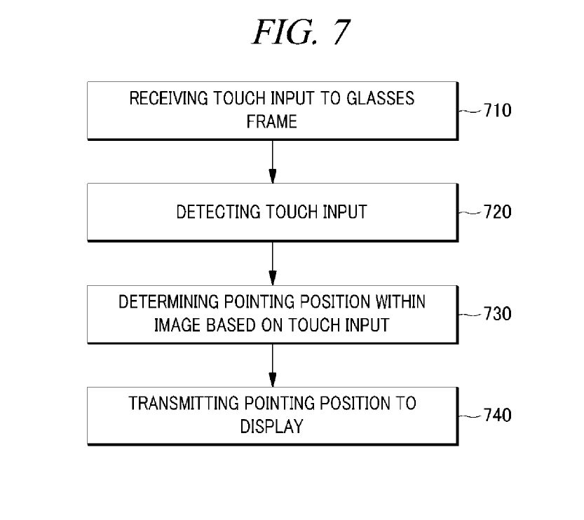

FIG. 7 shows an example processing flow for determining a pointing position within an image. The processing flow in FIG. 7 may be implemented by at least one glasses illustrated in FIGS. 1 to 6. Although illustrated as discrete blocks, various blocks may be divided into additional blocks, combined into fewer blocks, or eliminated, depending on the desired implementation. Processing may begin at block 710.

At block 710 (Receive Touch Input), glasses may receive a touch input to a glasses frame. In the above description regarding FIGS. 1 to 6, the glasses may include the glasses frame, and a wearer of the glasses may make the touch input to the glasses frame. Processing may proceed from block 710 to block 720.

At block 720 (Detect Touch Input), the glasses frame may detect the touch input received at block 710 by using any one of well-known touch input detecting schemes. By way of example, but not limited to, the touch input may be detected by using any of well-known touch sensitivity technologies, including but not limited to capacitive, resistive, infrared, and surface acoustic wave technologies, as well as other technologies using proximity sensor arrays or other elements for determining one or more contact points with the glasses frame. Processing may proceed from block 720 to block 730.

At block 730 (Determine Pointing Position), the glasses may determine a pointing position within an image displayed by a display based, at least in part, on the touch input detected at block 720. In some embodiments, the glasses may determine (x, y) or (x, y, z) coordinates of the pointing position on the display based on the detected touch input. Processing may proceed from block 730 to block 740.

At block 740 (Transmit Pointing Position to Display), the glasses may transmit the pointing position determined at block 730 to the display. By way of example, but not limited to, as the above description regarding FIGS. 1 to 6, the display may be mounted on a lens coupled with the glasses frame, or the display may be mounted on a non-transparent member coupled with glasses frame, or the display may be separated from the glasses. The image may be displayed by the display, and the transmitted pointing position may be shown on the image.

The examples described above, with regard to FIGS. 1-7, may be implemented in a computing environment having components that include, but are not limited to, one or more processors, system memory, and a system bus that couples various system components. Further, the computing environment may include a variety of computer readable media that are accessible by any of the various components, and includes both volatile and non-volatile media, removable and non-removable media.

Various modules and techniques may be described herein in the general context of computer-executable instructions, such as program modules, executed by one or more computers or other devices. Generally, program modules include routines, programs, objects, components, data structures, etc. for performing particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, but not limitation, computer readable media may comprise computer storage media and communications media.

Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Communication media typically embodies computer readable instructions, data structures, program modules, or other data in a modulated data signal, such as carrier wave or other transport mechanism. Communication media also includes any information delivery media. The term modulated data signal means a signal that has one or more of its characteristics set or changed in such a manner as to encode information in the signal. As a non-limiting example only, communication media includes wired media such as a wired network or direct-wired connection, and wireless media such as acoustic, RF, infrared, and other wireless media. Combinations of any of the above are also included within the scope of computer readable media.

Reference has been made throughout this specification to “one embodiment,” “an embodiment,” or “an example embodiment” meaning that a particular described feature, structure, or characteristic is included in at least one embodiment of the present invention. Thus, usage of such phrases may refer to more than just one embodiment. Furthermore, the described features, structures, or characteristics may be combined in any suitable manner in one or more embodiments.

While example embodiments and applications of the present invention have been illustrated and described, it is to be understood that the invention is not limited to the precise configuration and resources described above. Various modifications, changes, and variations apparent to those skilled in the art may be made in the arrangement, operation, and details of the methods and systems of the present invention disclosed herein without departing from the scope of the claimed invention.

One skilled in the relevant art may recognize, however, that the invention may be practiced without one or more of the specific details, or with other methods, resources, materials, etc. In other instances, well known structures, resources, or operations have not been shown or described in detail merely to avoid obscuring aspects of the invention.

What is claimed is:

1. A glasses comprising:
a glasses frame configured to detect a touch input to the glasses frame; and
a processor configured to determine a pointing position within an image displayed by a display based, at least in part, on the touch input.

2. The glasses of claim 1, wherein the display is separated from the glasses,
the processor is further configured to transmit the pointing position to the display, and
the pointing position is shown on the image displayed by the display.

3. The glasses of claim 1, further comprising:
a non-transparent member coupled with the glasses frame,
wherein the display is formed on the non-transparent member,
the processor is further configured to transmit the pointing position to the display, and
the pointing position is shown on the image displayed by the display.

4. The glasses of claim 1, further comprising:
a lens configured to be coupled with the glasses frame,
wherein the display is formed on the lens,
the processor is further configured to transmit the pointing position to the display, and
the pointing position is shown on the image displayed by the display.

5. The glasses of claim 4, further comprising:
a camera configured to be coupled with the glasses frame and capture the image around the glasses.

6. The glasses of claim 4, wherein the image is transmitted from an outside of the glasses to the display via a network.

7. The glasses of claim 4, further comprising:
a memory configured to store the image,
wherein the display is configured to display the image stored in the memory.

8. The glasses of claim 1, wherein the processor comprises:
a receiving unit configured to receive the detected touch input from the glasses frame;
a determination unit configured to determine the pointing position within the image based, at least in part, on the detected touch input; and
a transmitting unit configured to transmit the pointing position to the display.

9. The glasses of claim 1, wherein the glasses frame comprises:
a first glasses frame configured to detect a first direction touch input to the first glasses frame; and
a second glasses frame configured to detect a second direction touch input to the second glasses frame.

10. The glasses of claim 9, wherein the first direction touch input is associated with an x-axis direction on the display, and
the second direction touch input is associated with a y-axis direction on the display.

11. The glasses of claim 9, wherein the glasses frame further comprises:
a third glasses frame configured to detect a third direction touch input to the third glasses frame.

12. The glasses of claim 11, wherein the first direction touch input is associated with an x-axis direction on the display,
the second direction touch input is associated with a y-axis direction on the display, and
the third direction touch input is associated with a z-axis direction on the display.

13. The glasses of claim 1, further comprising:
an auxiliary input unit configured to receive an input for moving the pointing position.

14. The glasses of claim 13, wherein the auxiliary input unit includes at least one of a scroll and a ball.

15. The glasses of claim 1, wherein the glasses frame has thereon an on/off switch configured to stop or start an operation of the processor.

16. The glasses of claim 1, wherein the glasses frame has thereon a click unit configured to receive an instruction to click an object corresponding to the pointing position within the image.

17. The glasses of claim 1, wherein the image is zoomed in or zoomed out on the display based, at least in part, on the touch input.

18. A pointing device associated with a glasses, comprising:
a touch sensor configured to detect a touch input to a glasses frame of the glasses; and
a processor configured to determine a pointing position within an image displayed by a display based, at least in part, on the touch input.

19. A method performed under control of a glasses, comprising:
detecting a touch input to a glasses frame of the glasses; and
determining a pointing position within an image displayed by a display based, at least in part, on the touch input.

20. A non-transitory computer-readable storage medium having stored thereon computer-executable instructions that, in response to execution, cause a glasses to perform a method as claimed in claim 19.
